(19) United States
(12) Patent Application Publication
(10) Pub. No.: US 2004/0081801 A1
(43) Pub. Date: Apr. 29, 2004

(54) Grip-enhancing material

(76) Inventor: David M. Albert, Littleton, CO (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 10/687,940

(22) Filed: Oct. 17, 2003

Related U.S. Application Data
(63) Continuation-in-part of application No. 10/384,003, filed on Mar. 7, 2003.
Application No. 10/384,003 is a continuation-in-part of application No. 10/179,423, filed on Jun. 24, 2002, now Pat. No. 6,675,392.
Application No. 10/179,423 is a continuation of application No. 09/520,300, filed on Mar. 7, 2000, now Pat. No. 6,427,248.
Application No. 09/520,300 is a continuation-in-part of application No. 09/169,707, filed on Oct. 9, 1998, now Pat. No. 6,055,669.
(60) Provisional application No. 60/061,435, filed on Oct. 9, 1997.

(51) Int. Cl. B32B 3/26; B32B 3/12; B32B 15/04

(52) U.S. Cl. 428/159; 428/343

(57) ABSTRACT

A grip-enhancing material for preventing two objects in contact with each other from slipping is disclosed herein. The grip-enhancing material of the present invention includes a plurality of recesses, such as suction cups, positioned on a base material. The suction cups may be connected to the base material by a stem or may be connected directly to the base material. The base material can be affixed to a first object with adhesive and the grip-enhancing material engages a second object upon contact through suction and/or friction forces. In one application, the grip-enhancing material may be applied to prevent heavy objects placed on smooth surfaces from slipping. In another application, the grip-enhancing material is used to enhance the frictional characteristics of gripping surfaces on certain objects. Further, the grip-enhancing material may be affixed directly to various body parts to enhance a person's ability to grip various objects.

### CROSS-REFERENCE TO RELATED APPLICATIONS

This application is a continuation-in-part of U.S. application Ser. No. 10/384,003, filed on Mar. 7, 2003, which is a continuation-in-part of U.S. application Ser. No. 10/179,423, filed on Jun. 24, 2002, which is a continuation of U.S. application Ser. No. 09/520,300 filed Mar. 7, 2000, U.S. Pat. No. 6,427,248, which is a continuation-in-part of U.S. application Ser. No. 09/169,707, filed Oct. 9, 1998, U.S. Pat. No. 6,055,669, which claims the benefit of U.S. Provisional Application No. 60/061,435, filed Oct. 9, 1997. Each of the above-identified patent applications or patents is hereby incorporated by reference as if fully disclosed herein.

### FIELD OF THE INVENTION

This invention relates to a material used to prevent contact surfaces between various objects from slipping, and more particularly to a grip-enhancing material that utilizes friction and/or suction forces that may also be selectively removable or permanently affixed to various objects including body parts.

### BACKGROUND OF THE INVENTION

Many different products on the market are designed to be in physical contact with other objects when in use. More particularly, these products may include objects that rest on a floor (i.e. rugs, mats, furniture), objects that rest on countertops (i.e. kitchen appliances, lab equipment, tools), objects with handles or gripping surfaces (i.e. crutches, walkers, wheel chairs, tools), and objects used to grip other objects, such as gloves. However, many of these products are seemingly designed without consideration of the friction or the lack thereof between a particular product and another object when in contact with each other.

Many products on the market that are designed to rest on another surface are often supplied to consumers without consideration of how easily a particular object might slip across the surface upon which it is to rest. This oversight can result in serious problems when these products are used. For example, the bottom sides of some area rugs are simply made up of the back side of the fabric and weaving used to create the rug. Typically, very little friction is created between the bottom surface of the area rug and a smooth floor, because the bottom side of the rug is generally smooth and hard. Therefore, it may be hazardous to place these area rugs on a smooth floor, because the rugs may slip when stepped on or walked across by a person. Other products on the market supplied without consideration to the surface upon which they are resting include products designed to rest on countertops. For example, some kitchen appliances are supplied with smooth plastic legs that slide easily when placed upon a smooth kitchen countertop. A blender that stands on smooth plastic legs may slide across a smooth countertop when in use due to the vibration caused by the motor. Left unsupervised, the blender may slide off the countertop and cause damage to the floor, the blender, or perhaps injure a bystander.

Some products on the market are designed with a handle or gripping surface and are supplied to consumers without consideration of how a particular object can be gripped without slipping. For example, crutches and walkers that have a smooth gripping surface may not have a suitable means for enhancing a person's grip on the object when in use. To overcome this oversight, some products on the market may be supplied with a sheath on the gripping surface to enhance a person's grip. However, the sheath may only enhance the person's grip on the sheath and not the object itself, because the sheath may slip on the gripping surface.

Various types of work and athletic gloves are used to assist in maximizing a person's use of their hands. Generally gloves tend to improve the control that a user has over objects as well as help the user avoid blisters and other physical damage to the hands. Several examples of when gloves can be used to increase a person's control over an object include: a bowling ball glove, a baseball batting glove, a golf glove, driving gloves, and work gloves.

Numerous available gloves are made of materials that help protect the user's hands from injury but have minimal or even deleterious effects on the user's grip. These gloves tend to be of a thicker more durable material, but have little or no control-enhancing material to increase the user's control over gripped objects.

Other available gloves have a frictional material at locations where the user's hand engages objects. The frictional material helps create a controlling effect on the object, but is ineffective if the user shifts his or her hand and the frictional material is disengaged from the surface of the object.

An excellent example of these shortcomings is seen in bowling ball gloves. Several available bowling ball gloves assist the user in maintaining the proper hand position, but do not improve the contact performance where the bowler's hand engages the bowling ball.

Further, other available bowling ball gloves have a frictional material at locations where the user's hand engages the bowling ball. The frictional material is typically a smooth rubber surface or a rough sand-paper like surface. The frictional material helps create a controlling effect on the item gripped, but is ineffective if the user slightly shifts his or her hand and the frictional material is disengaged from surface of the item.

It is with these shortcomings in mind that the instant invention was developed.

### SUMMARY OF THE INVENTION

The grip-enhancing material of the present invention generally comprises a base material with a plurality of recesses, such as suction cups, positioned on the base material, and wherein the grip-enhancing material is placed between contact surfaces of two objects in order prevent slipping through suction and/or friction forces. In any of the embodiments of the present invention, the base material and suction cups may be constructed of either plastic or polyurethane. In one application, the grip-enhancing material may be applied to prevent heavy objects placed on smooth surfaces, such as floors, bath tubs, countertops, laboratory tables, tool benches, and the like, from slipping. In another application, the grip-enhancing material is used to enhance the frictional characteristics of gripping surfaces on certain objects, such as power tools, crutches, walkers, wheel chairs, and the like. Further, the grip-enhancing material may be used on the exterior surfaces of gloves to enhance a person's ability to grip various objects. The grip-enhancing material can also be applied directly to the skin of a user, on virtually any exterior body part, in order to enhance the grip of that body part on another body part or an inanimate object.

In one particular embodiment of the invention, the grip-enhancing material for preventing a first object and a second object in contact with each other from slipping, comprises: a base material forming a plurality of recesses therein defining a depth, the recesses formed at a density of approximately 180 to 300 per square inch, wherein the depth of the recesses is approximately 1/64 to 1/32 of an inch, and wherein the first object contacts the base material and the grip-enhancing material engages a smooth surface of the second object upon contact through suction and friction forces. The recesses of the grip-enhancing material may also define diameters of approximately 1/64 or greater inches.

In a second embodiment of the present invention, the grip-enhancing material for preventing a first object and a second object in contact with each other from slipping, comprises: a base material; a plurality of suction cups formed at a density of 4 to 7 per square inch, said suction cups defining diameters of approximately ¼ to ½ inches, wherein each of said plurality of suction cups is connected with said base material by a stem; and wherein said first object contacts said base material, and said grip-enhancing material engages a smooth surface of said second object upon contact through suction and friction forces.

In a third embodiment of the present invention, the grip-enhancing material for preventing a first object and a second object in contact with each other from slipping, comprises: a base material; a plurality of suction cups formed at a density of 14 to 18 per square inch, the suction cups defining a diameter of approximately 1/16 to ¼ inches, wherein each of the plurality of suction cups is connected with the base material by a pedestal; and wherein the first object contacts the base material, and the grip-enhancing material engages a smooth surface of the second object upon contact through suction and friction forces.

In a fourth embodiment of the present invention, the grip-enhancing material for preventing a first object and a second object in contact with each other from slipping, comprises: a base material; a plurality of suction cups, each of the plurality of suction cups defining a diameter of ⅛ to 3/16 inches and arranged adjacent to at least one suction cup, wherein each of the plurality of suction cups has a concave side facing away from the base material and a convex side connected directly with the base material, and forming a plurality of voids between the convex sides of each of the plurality of suction cups and the base material; and wherein the first object contacts the base material, and the grip-enhancing material engages a smooth surface of the second object upon contact through suction and friction forces.

In another application, the control-enhancing material of the present invention includes a plurality of recesses, such as suction cups, positioned on the palm portion of the a glove. The areas covered by the control-enhancing material include the palm area, the underside of the index finger, the underside of the thumb, the underside of the little finger, and the underside of the middle and ring fingers. Basically, the control-enhancing material is positioned at all or some of the areas on the glove that contact objects when the glove is worn on the hand of the user and the user is holding an object. The control-enhancing material works to grip the surface of an object by a suction force and a friction force to engage the material with the object. The additional grip is maintained even though the user moves his or her hand slightly either away from, towards, or laterally with respect to an object. The control-enhancing material also helps cushion the user's hand from objects.

In more detail, the glove of the present invention engages an outer surface of an object, the glove including a palm portion, a control-enhancing material attached to the palm portion, and the control enhancing material engaging the object upon contact through suction and frictional forces.

Further, the glove includes control-enhancing material that has a plurality of suction cups. The glove could also include suction cups each having a flexible stem and an engagement end attached to the stem, the engagement end spaced away from the glove. The engagement end could be concave. The suction cups can be attached to a base material, with the base material being attached to the glove.

Other aspects, features and details of the present invention can be more completely understood by reference to the following detailed description in conjunction with the drawings, and from the appended claims.

### BRIEF DESCRIPTION OF THE DRAWINGS

FIG. 1 shows a bowling glove incorporating the suction cups of a first embodiment of the present invention.

FIG. 2 shows a bowling glove incorporating the suction cups of a second embodiment of the present invention.

FIG. 3 shows a bowling glove incorporating the suction cups of a third embodiment of the present invention.

FIG. 4 is a section taken along line 4-4 of FIG. 1.

FIG. 5 is a section taken along line 5-5 of FIG. 2.

FIG. 6 is a section taken along line 6-6 of FIG. 3.

FIG. 7A is a section view of a first embodiment of the present embodiment in engagement with the outer surface of the bowling ball.

FIG. 7B is a section view of a second embodiment of the present invention in engagement with the outer surface of the bowling ball.

FIG. 7C is a section view of a third embodiment of the present invention in engagement with the outer surface of the bowling ball.

FIG. 8 shows a glove incorporating the suction cups of the first embodiment of the present invention.

FIG. 9 shows a glove incorporating the custom-positioning of the suction cups of the present invention.

FIG. 10 is a section taken along line 10-10 of FIG. 9.

FIG. 11 shows the present invention engaged to the surface of a baseball bat.

FIG. 12 shows the present invention engaged to the surface of a golf club.

FIG. 13 shows a fourth embodiment of the grip-enhancing material.

FIG. 14 is a section taken along line 14-14 of FIG. 13.

FIG. 15 shows an alternative configuration of the fourth embodiment of the grip-enhancing material.

FIG. 16 is a section taken along line 16-16 of FIG. 15.

FIG. 17 shows the grip-enhancing material affixed to the bottom surface of an area rug.

FIGS. 17A-17C show the grip-enhancing material affixed to the bottom surface of the area rug in various configurations.

FIG. 18 shows the grip-enhancing material affixed to the bottom support legs of a blender.

FIG. 19 shows the grip-enhancing material placed on a smooth gripping surface of a crutch handle.

FIGS. 20A-20B show the grip-enhancing material placed between a sheath and a gripping surface of a power saw.

FIG. 21 shows the grip-enhancing material with adhesive located on a base material.

FIG. 22 shows the grip-enhancing material supplied in a roll with a dispenser.

FIG. 23A shows the grip-enhancing material applied directly to a user's finger.

FIG. 23B shows the grip-enhancing material applied directly to a user's palm.

FIG. 24 shows the grip-enhancing material supplied in a pre-formed shape of a user's finger and a user's palm.

### DETAILED DESCRIPTION OF THE INVENTION

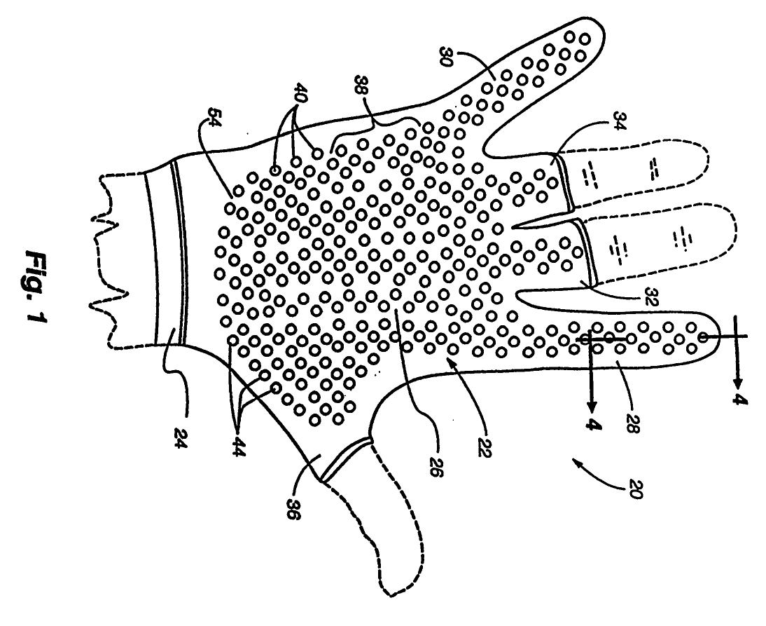

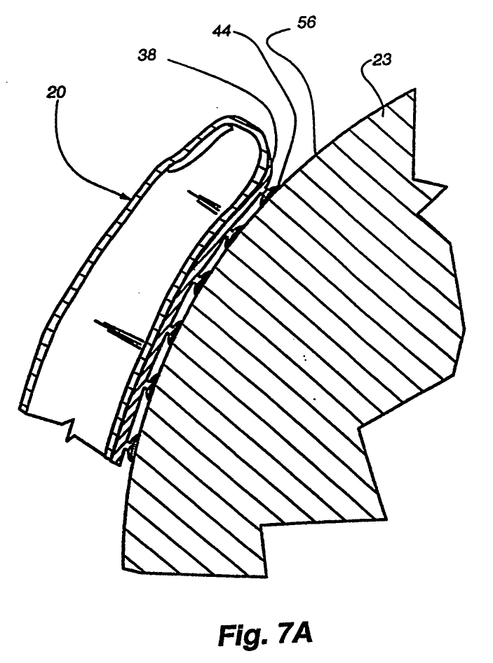

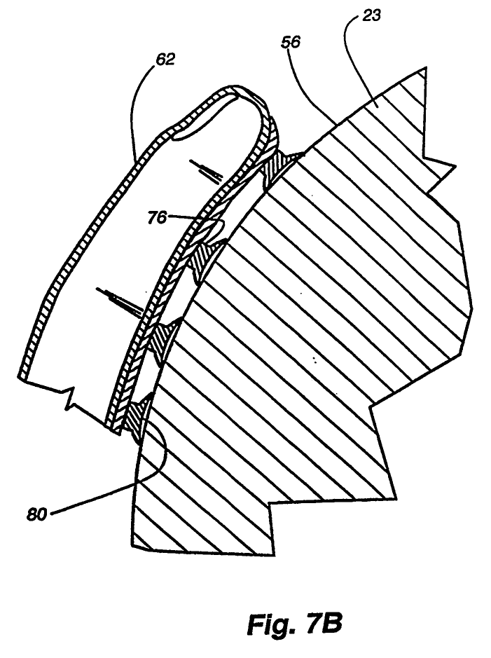

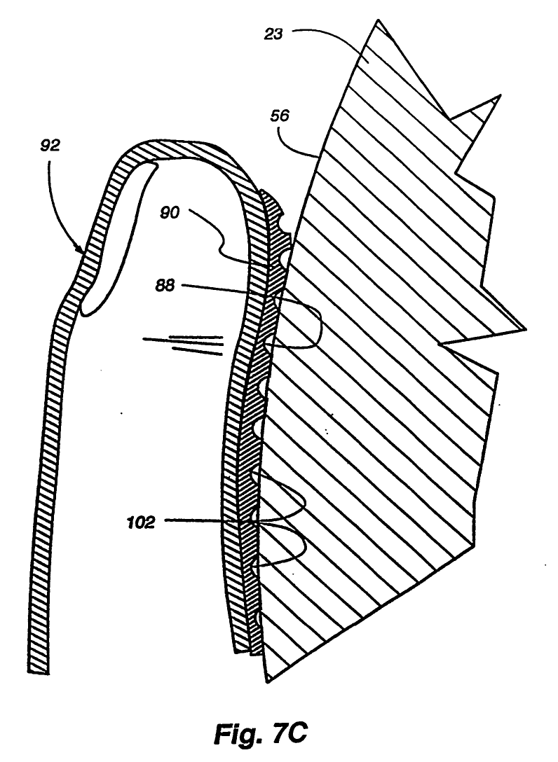

An example of a grip-enhancing glove can be envisioned with reference to a bowling ball glove. FIGS. 1-7C show a bowling glove 20 with controlling surfaces attached to the palm side 22 of the glove to enhance the user's control of the bowling ball 23 (see FIGS. 7A-7C). The glove is typically made of a leather, vinyl, or other suitable material, and has an adjustable closure around the base rim 24, such as a hook-and-loop material clasp. Velcro® is a good example of such a hook and loop material clasp. Typical bowling gloves have a palm portion 26 including an index finger 28, a little finger 30, a truncated middle 32 and ring 34 fingers, and truncated thumb 36 portions. On the middle and ring finger portions the glove extends up to the first knuckle of the finger, and on the thumb portion the glove typically extends only over the base knuckle of the thumb. The glove also has a back side portion, which extends across the back of the hand and attaches on either side to the palm portion.

The control-enhancing 38 material of the present invention includes a plurality of recesses 40, such as suction cups 44, positioned on the glove 20 on the palm portion 26, including the underside of the index finger portion 28, the underside of the little finger portion 30, and the underside of the middle 32 and ring 34 fingers. Basically, the control-enhancing material is positioned at all or some of the areas on the glove 20 that contact the bowling ball when the glove is worn on the hand of the user and the user is holding a bowling ball.

The control-enhancing material 38 works to grip the surface of the bowling ball 23 by a suction force and a friction force. The additional grip is maintained even though the user moves his or her hand slightly either away from, towards, or laterally with respect to the bowling ball 23, as is explained in more detail below. The control-enhancing material 38 also helps cushion the user's hand from the bowling ball. The control-enhancing material 38 allows the user to have more control during the entire delivery of the bowling ball.

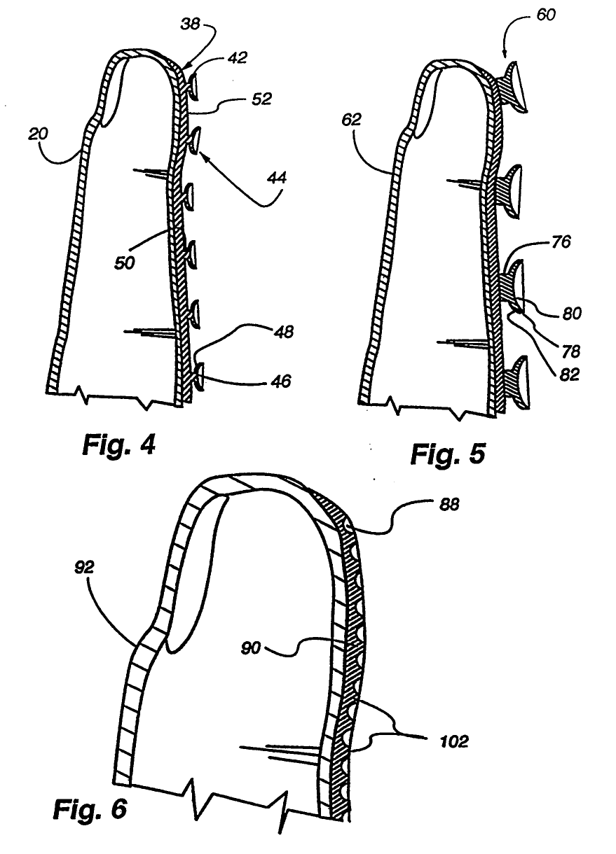

FIGS. 1 and 4 show a first embodiment of the present invention. A plurality of relatively small suction cups 44 are mounted on the palm portion 26, including under the index 28, little 30, thumb 36 and portions of the middle 32 and ring 34 fingers. The diameter of the suction cups is preferably 1/16^{th} of an inch to ¼^{th} of an inch in diameter at their engagement ends 42. The suction cups 44 are positioned at a relatively high density, such as preferably between 14 and 18 per square inch. This size and density of suction cups provides for a relatively smooth release when the bowling ball disengages from the control-enhancing material because the suction cups are relatively small.

The suction cups 44 each have an engagement end 42 shaped with a concave side 46 facing outwardly and a convex side 48 facing toward the palm portion 26. A preferably flexible pedestal 50 extends from the convex side of the engagement end to a base material 52. The base material 52 is preferably the same material as the suction cups, and is flexible. The base material helps support the suction cup 44 and maintains their spacing relative to one another. The base material is fixedly or releasably attached to the glove 20 in the appropriate desired locations. The base material 52 and the suction cups 44 are preferably formed of a flexible resilient material, such as urethane or plastic.

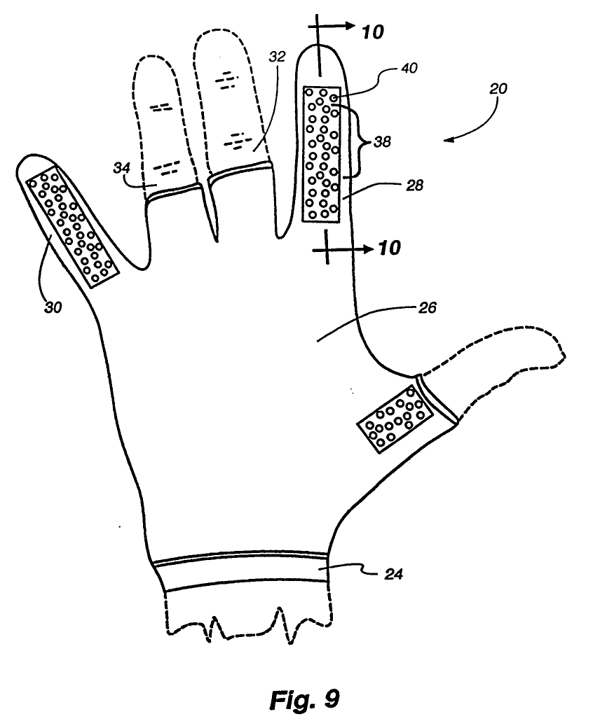

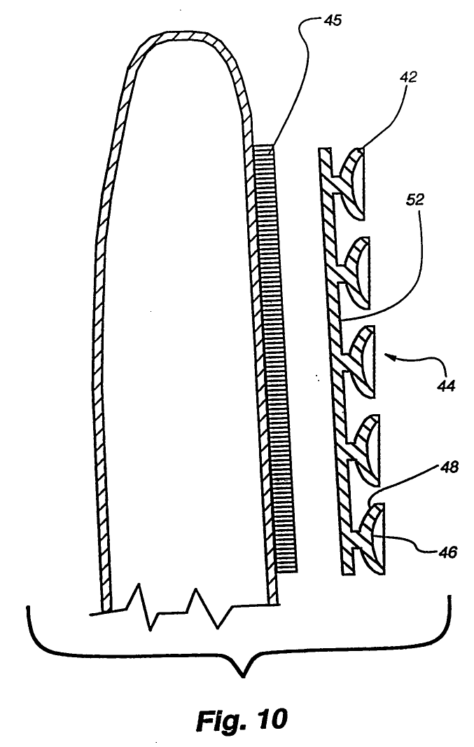

While the suction cups are preferably located as described above, they can be positioned only on the desired location, for instance on the fingers and not on the palm. As shown in FIGS. 9 and 10 a hook and loop fastener 45, such as the fastener sold under the trademark Velcro®, can be used to attach the base material 52, and as such the suction cups 44, to the desired location on the glove 20. This allows the user to custom-position the suction cups 44 for the most effect. The area of the glove 20 covered by the control-enhancing material 38, whether over the entire surface of the palm portion 26 or only under one finger, is hereinafter referred to as the “control area” 54 (see FIG. 1).

When the control area 54 is engaged with the outer surface of a bowling ball, the suction cups 44 engage and attach to the continuously curving bowling ball surface 56 (see FIG. 7A). Since the engagement end 42 of the suction cups 44 are positioned on flexible pedestals, they extend away from the glove 20. The suction cups 44 thus can stay connected to the surface 56 of the bowling ball even though the hand or finger is pulled away slightly from, pushed towards, or moved laterally with respect to the bowling ball. The pedestal 50 for each suction cup 44 flexes to allow the hand to move relatively independently from the engagement end 42 of each of the suction cups 44. Each suction cup 44 attaches independently at discrete locations to the surface 56 of the bowling ball 23.

This is advantageous over existing sticky surface gloves where a slight movement of the finger or hand away from the bowling ball disengages the sticky surface from the outer surface of the bowling ball. For instance, the tip of the index finger is often not in direct engagement with the outer surface of the bowling ball, but is instead slightly raised off the outer surface of the bowling ball. With the present invention, the suction cups near the tip of the index finger will remain intact with the bowling ball since they each extend away from the surface of the glove and allow the finger to be lifted slightly off the surface of the bowling ball without disengaging the suction cups.

In FIG. 1, the relatively small sized suction cups extend along the under surface of the index finger 28, the little finger 30, below the thumb 36, across the palm, and extend up the middle 32 and ring 34 fingers. The extension of the suction cups 44 away from the surface of the base material 38 allows for lateral adjustment as well as vertical adjustment and movement of the suction cups 44 once applied to the outer surface of the bowling ball to facilitate a more complete connection of the suction cups 44 to the bowling ball with respect to the position of the finger or hand.

When the bowling ball 23 is released from the hand of the user, the suction cups 44 each individually disconnect from the surface 56 of the bowling ball 23. During the delivery movement (back swing, down swing and release), the suction cups keep the user in closer control of the bowling ball, and assist in increasing rotation, accurate handling and positioning of the bowling ball during the delivery movement.

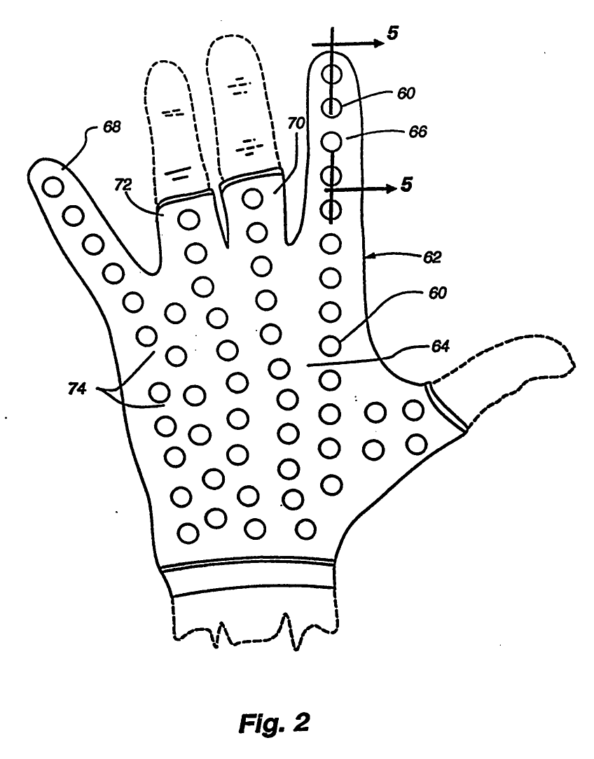

FIGS. 2 and 5 show a second embodiment of the present invention where the suction cups 60 are relatively larger than in the first embodiment and are preferably directly attached to the material of the glove 62. The general construction and operating of the glove and the suction cups is similar to that described in the first embodiment. The suction cups 60 (new reference numerals are used for clarity) have the same construction as those previously described, and can be individually attached by adhesive, sewing or the like to the glove as desired. The suction cups 60 still extend along the palm 64, along the underside of the index 66 and little 68 fingers, as well as on the portions of the glove covering the middle 70 and ring 72 fingers. The suction cups 60 together form the control-enhancing material, and the area covered by the suction cups is considered the control area. These relatively larger suction cups 60 are preferably approximately ¼ of an inch to ½ of an inch in diameter. The larger suction cups are spaced further apart than in the first embodiment, such as preferably approximately 4-7 suction cups per square inch. This size and density of suction cups 60 provides for a relatively less smooth release when the bowling ball 23 disengages from the control-enhancing material 74 because the suction cups 60 are relatively larger.

The suction cups 60 each have a flexible stem 76, and an engagement end 78 defining a concave surface 80 and a convex surface 82. As with the first embodiment, these suction cups 60 still allow relative movement of the finger or hand away from or toward the ball, or laterally with respect to the ball without disengaging the attachment of the suction cup to the outer surface of the bowling ball. The suction cups are individually formed of a plastic or urethane material, or other suitable material. The suction cups can also be attached on a unitary base material if desired, as in the first embodiment. In addition, the larger suction cups can be positioned only in particular locations as desired, as described above with regard to the first embodiment.

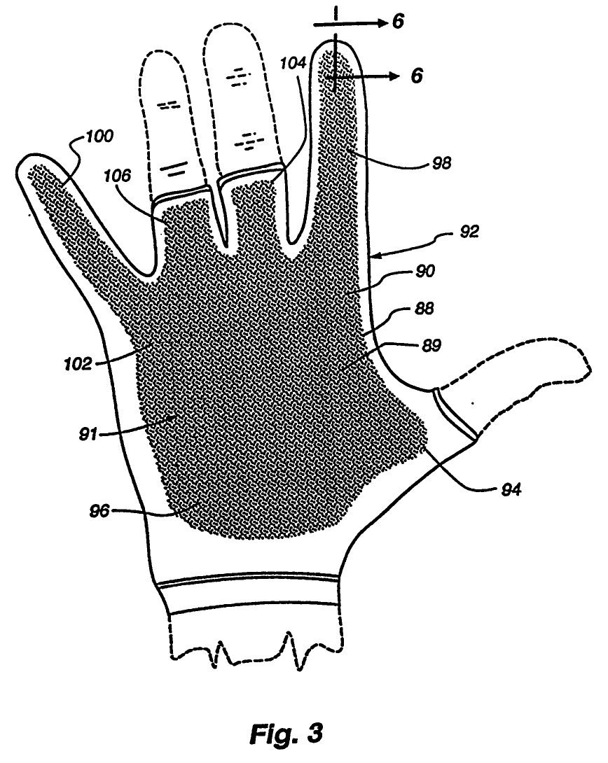

FIGS. 3 and 6 show another embodiment of the present invention where the suction cups are each formed by an individual recesses 88 in a base material. The general operation of the glove and the suction cups is similar to that described in the first embodiment. The base material 90 can be of uniform thickness or varying thickness. The base material 90 is applied and attached, either fixedly or removably, to the glove 92 below the thumb 94, along the palm 96, along the underside of the index 98 and little 100 fingers, and along the underside of the middle 102 and ring 104 finger where covered by the glove. The recesses 88 together form the control-enhancing material 89, and the area covered by the recesses is considered the control area 91. The recesses 88 formed in the base material 90 act as suction cups and are smaller than the suction cups of the first and second embodiments. They also provide a suction and frictional attachment to the outer surface 56 of the bowling ball 23 to provide additional control during delivery. The base material 90 is a plastic or polyurethane material, or other suitable material that is flexible and compressible. The base material 90, being flexible, allows slight movement of the glove with respect to the bowling ball without affecting the contact of the base material to the outer surface 56 of the bowling ball 23.

The recesses 88 are preferably circular and approximately 1/64 of an inch to ⅛ of an inch in diameter. The recesses are formed at a density level of between 180 and 300 recesses per square inch, preferably 250. The portion 102 of the base material 90 between the recesses 88 acts to enhance the frictional engagement between the glove 92 and the outer surface 56 of the bowling ball 23.

FIG. 6 shows the recesses 88 in section. The recesses 88 are concave having a generally semicircular shape. The recesses 88 are preferably approximately 1/64 to 1/32 of an inch deep. This size and density of recesses provides for a smooth release when the bowling ball disengages from the control-enhancing material because the suction cups are smaller.

FIGS. 7A-7C show representative cross-sections of the first, second, and third embodiment, respectively. The suction cups of the respective embodiments are applied to the outer surface 56 of the bowling ball 23 and follow the curvature of the outer surface of the bowling ball continuously. As can be seen, the suction cups position themselves in a generally curved orientation to exactly match the outer surface of the bowling ball and provide excellent engagement with the bowling ball. In addition, since the suction cups extend from the finger and hand of the user, and are flexible, the user's slight movement of the finger toward and away from the surface of the bowling ball or laterally with respect to the surface of the bowling ball does not necessarily disengage the suction cups from the surface of the bowling ball.

With respect to the first and second embodiments, the suction cup engagement end extends from the glove on a pedestal, which spaces the engagement ends away from the finger and allows for the flexibility in hand and finger positioning. As the ball is released, the force of the ball leaving the hand overcomes the attachment and controlling force created by the suction cups. While engaging the bowling ball, the control-enhancing material imparts additional force to the bowling ball to improve the user's control and revolution generation. The suction cups can be of a circular shape, oval shape, or other suitable shape, with the circular or oval shapes being preferred.

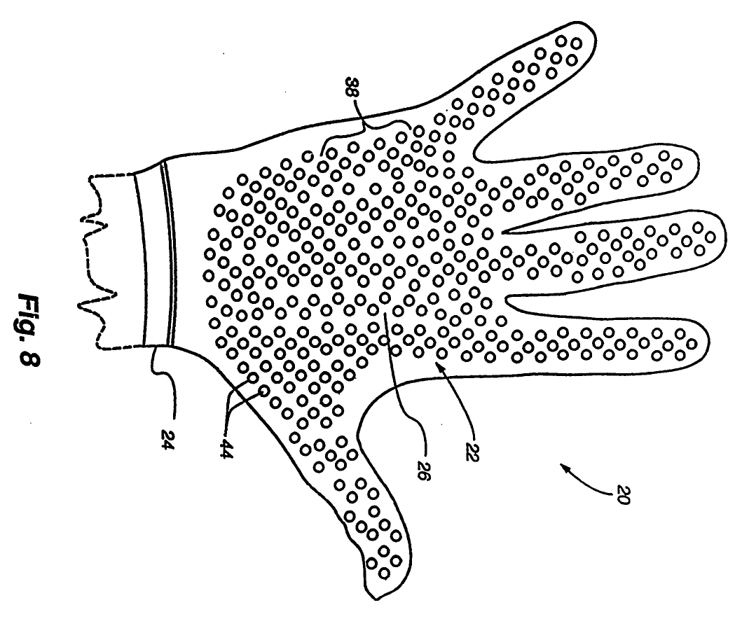

In addition to a bowling ball glove, FIG. 8 shows a grip-enhancing glove where the glove encloses the entirety of the user's hand. The glove has a palm portion including an index, little, middle, and ring fingers, and thumb portions. The glove also contains a back side portion, which extends across the back of the hand.

Attached to the palm portion of the grip-enhancing glove is a control-enhancing surface. The surface material includes a plurality of recesses, such as suction cups, positioned on the glove on the palm portion, including the underside of the index, little, middle, and ring fingers, and the underside of the thumb as was described more fully above for the bowling ball glove. Note, as was discussed above for the bowling ball, the control-enhancing material may be removably attached to a desired location on the glove. This allows the user to custom-position the control-enhancing material at the appropriate desired locations on the glove.

FIG. 9 shows a bowling glove that has discrete patches or sections of control-enhancing material positioned at selected locations on the palm portion of the glove. The patches can be attached with a removable attachment material, such as a removable attachment material sold under the trademark Velcro®, appropriately affixed to the palm and patch. The attachment material should be secure enough to keep the control-enhancing material from being removed from the glove when an object is released from the hand. The patches can have a variety of shapes, including squares, rectangles, circles, ovals, or irregular shapes, as desired, for more or less effect, as desired. Patches of differing shape can be used for different applications, or patches of similar shape can be reconfigured on the palm portion.

The control-enhancing material works to grip the surface of a plurality of objects by suction force and friction force. The control-enhancing material allows the user to have greater control over the gripped object and help cushion the user's hand from impacts sustained through the object.

It is envisioned that the glove will enhance gripping of a plurality of objects including cylindrically-shaped objects as well as to other irregularly shaped objects. As long as the shape of the object and the surface of an object allows at least a suction force or a friction force to be developed between the glove and the surface of the object, the control-enhancing material will improve grip and control. The control enhancing surface works best when used to enhance the control via both friction and suction on a relatively smooth surface, such as plastic, polished leather, metals, or the like.

The control-enhancing material of the grip-enhancing glove is envisioned to have the same three embodiments as described above for the bowling ball glove.

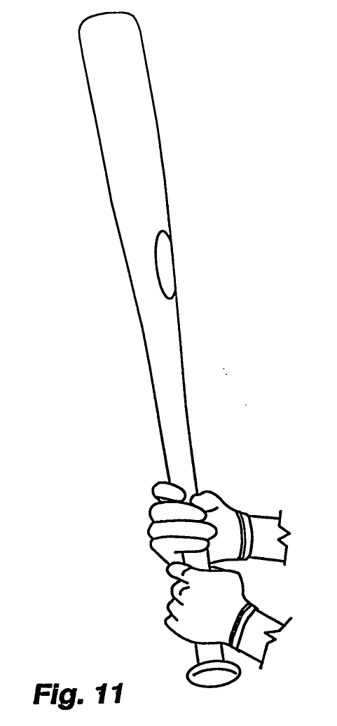

With reference to FIGS. 11-12, several further examples will help illustrate possible uses of the grip-enhancing glove. FIG. 11 shows the control-enhancing surface attached to the palm side of a baseball batting glove to enhance the user's control over a baseball bat. The control-enhancing surface engages the surface of the handle of the bat with both a friction and suction force. FIG. 12 shows the control-enhancing surface attached to the palm side of a golf glove to enhance the user's grip when holding a golf club. The control-enhancing surface attached to the palm side of many styles of gloves can enhance gripping and control of a gripped object. For instance, such technology can be used on a glove for a fishing pole, and a variety of common tools, including a shovel, rake, hoe, ax and the like.

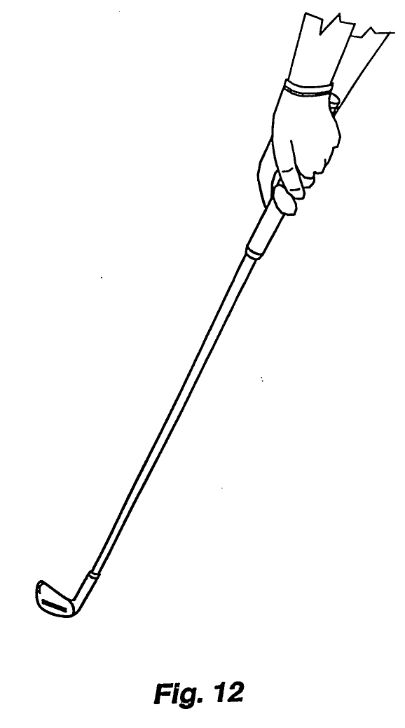

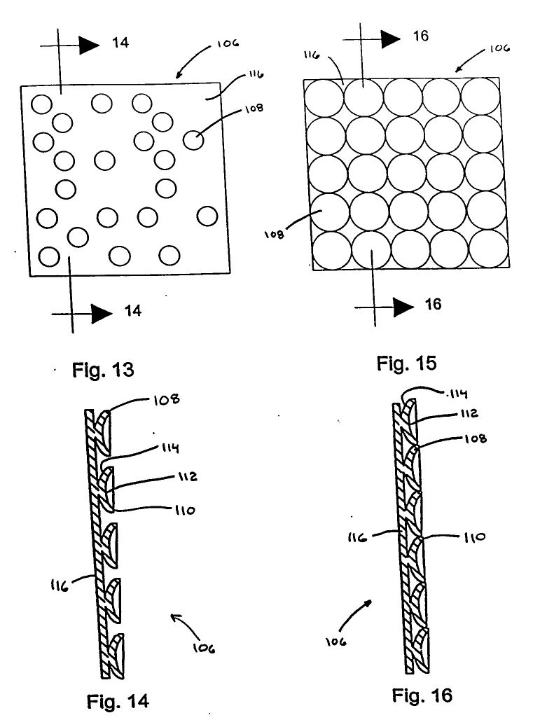

FIGS. 13-16 show a fourth embodiment of the grip-enhancing material 106, which can be utilized in the same manner as the three embodiments of the grip-enhancing material described above. In this fourth embodiment, the grip-enhancing material 106 utilizes a plurality of suction cups 108 (new reference numerals are used for clarity) having a similar construction to those described in the first and second embodiments. The suction cups 108 each have an engagement end 110 defining a concave surface 112 and a convex surface 114. However, unlike the first and second embodiments, the convex surface 114 of each suction cup 108 in the fourth embodiment is attached directly to a base material 116. As with the above described embodiments, the base material 116 and suction cups 108 are preferably formed of a plastic or urethane material, or any other suitable material. In this embodiment, the preferred diameter of each suction cup is ⅛″ to 3/16″ at the engagement end with the suction cups positioned tangentially to each other, as shown in FIGS. 15 and 16. A density level of 28 to 64 suction cups per square inch is also preferred. However, the suction cups may also have diameters within the ranges for the three previously described embodiments, and may also be arranged on the base material within their respective preferred densities.

While the four embodiments of the grip-enhancing material described above are typically utilized in conjunction with a grip-enhancing glove, it is envisioned that the grip-enhancing material may also be used to prevent contact surfaces between various objects from slipping without utilizing a grip-enhancing glove. The base material of the grip-enhancing material may be permanently affixed to a particular object by any suitable means, such as glue, stitching, and the like. Alternatively, the base material may be selectively removable from a particular object by utilizing materials such as Velcro®, tape, and the like. With the base material attached to an object, the suction cups can engage a smooth surface of another object to prevent slipping between the two objects by utilizing friction and/or suction forces. The invention may also be configured such that the suction cups attach to one object with suction forces and the base material engages a smooth surface of another object to prevent slipping between the two objects through increased friction forces. Alternatively, the grip-enhancing material may be configured such that suction cups extend from opposite sides of the base material, which would allow the grip-enhancing material to be affixed to two objects by the suction forces of the suction cups.

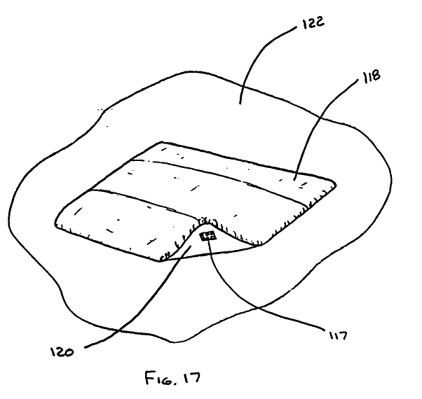

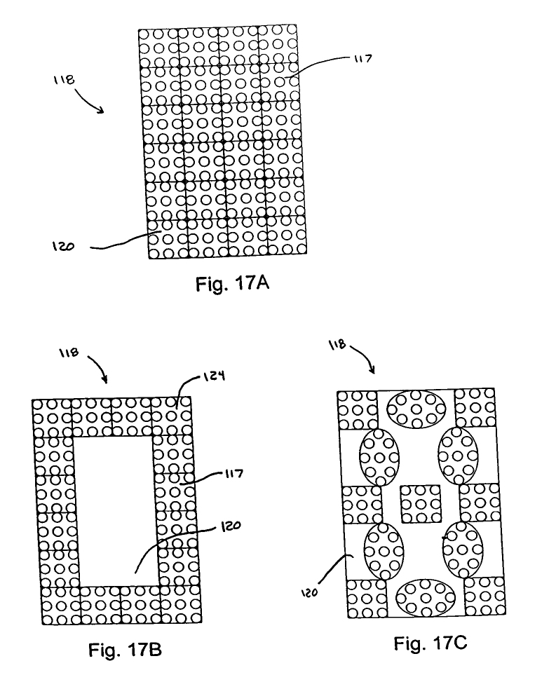

In general, the grip-enhancing material may be applied to prevent heavy objects placed on smooth surfaces, such as floors, bath tubs, countertops, laboratory tables, tool benches, and the like, from slipping. FIGS. 17-20 illustrate various examples of how any of the four embodiments of the grip-enhancing material can be used to prevent objects in contact with smooth contact surfaces from slipping by utilizing friction and/or suction forces.

One application for the grip-enhancing material is to prevent an object placed on a floor from slipping when a person steps on the object or walks over it. For example, FIG. 17 shows a grip-enhancing material 117 utilized as a backing for an area rug 118. The grip-enhancing material 117 is attached to a bottom contact surface 120 of the area rug 118 and engages a floor 122 with friction and/or suction forces to prevent the area rug 118 from slipping on the floor 122. When a person steps on the area rug 118, the person's weight exerts forces on the area rug 118 and the grip-enhancing material 117 in a downward direction and in a direction parallel to the surface of the floor. However, the friction and/or suction forces of the grip-enhancing material I 17 causes the rug to resist slipping across the floor. The grip-enhancing material works particularly well under area rugs resting on tile, stone, or wood floors. The grip-enhancing material 11 7 can also be used in other similar situations, such as preventing bath mats from slipping on a bath tub.

The grip-enhancing material 117 may also be configured geometrically on an object in various ways to achieve optimum results depending on the particular application. For example, in FIG. 17, the grip-enhancing material 117 is placed only on the corners of the area rug 118. FIG. 17A shows the grip-enhancing material 117 attached to the area rug 118 such that it covers the entire contact surface 120 of the area rug 118. In another application, the grip-enhancing material 117 is placed only on a perimeter area 124 of the contact surface 120 of the area rug 118, as shown in FIG. 17B. Alternatively, the grip-enhancing material 117 may be arranged randomly or in a pattern on the contact surface 120 of the area rug 118, as shown in FIG. 17C. It should be understood that the available configurations are not limited to those depicted herein.

In another application, the grip-enhancing material is used to prevent an object supported on legs from slipping on a smooth surface. For example, the grip-enhancing material may be used to prevent kitchen appliances from slipping on smooth kitchen counter tops. As shown in FIG. 18, the grip-enhancing material II 7 is attached to the bottoms of support legs 126 on a blender 128. The grip-enhancing material 117 engages a smooth counter top 130 with suction and/or friction forces to help prevent the blender 128 from slipping on the counter top 130. In a similar manner, the grip-enhancing material may be placed on the support legs of other objects, such as tools, laboratory equipment, office equipment, furniture, tables, chairs, and the like. The grip-enhancing material can also be utilized with the existing plastic cups having a carpet material affixed to the bottom to prevent them from sliding. It should also be understood that the grip-enhancing material may be placed on objects without legs that rest on countertops and tables, such as cutting boards, knife holders, and the like.

The grip-enhancing material may also be utilized with devices that are used to prevent furniture legs from scratching the floor. One such device is a plastic cup having a small piece of carpet or fabric attached to its bottom. The plastic cup fits over the bottom of the furniture leg and the small piece of carpet or fabric rests between the plastic cup and the floor. Although this device prevents the furniture leg from scratching the floor, the carpet or fabric does not prevent the furniture from easily sliding across the floor. To prevent the furniture from easily sliding across the floor while providing scratch protection, the grip-enhancing material can be used in conjunction with the plastic cup instead of carpeting or fabric.

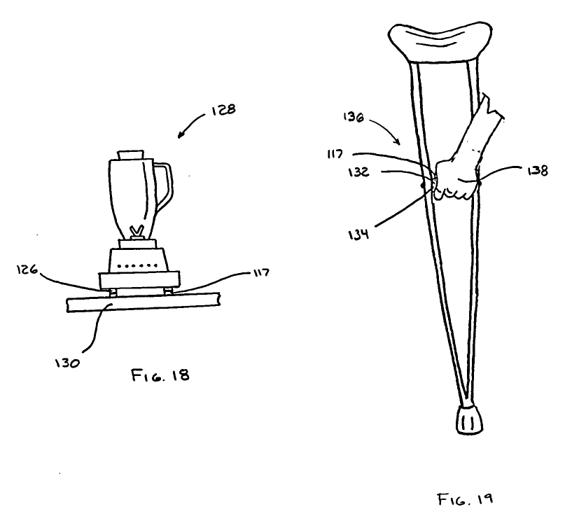

In other applications, the grip-enhancing material may be used to prevent slipping between a user's hand and objects equipped with a gripping surface. As shown in FIG. 19, the grip-enhancing material 117 is placed on a smooth gripping surface 132 of a handle 134 on a crutch 136. The grip-enhancing material engages the smooth surface 132 utilizing friction and suction forces to prevent a user's hand 138 from slipping on the crutch handle 134. The grip-enhancing material can also be used in other similar situations on objects equipped with gripping surfaces or handles, such as walkers, wheel chairs, free weights, small tools, and the like.

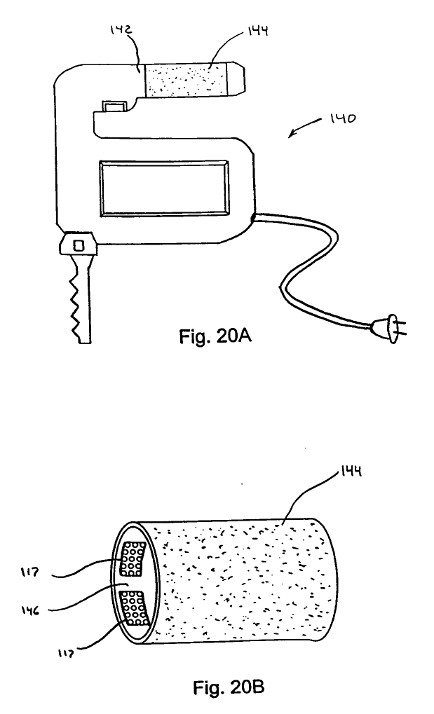

In some applications, the grip-enhancing material need not be placed directly between a user's hand an object's gripping surface. For instance, some objects equipped with a gripping surface are supplied with a sheath that fits over the gripping surface to prevent the user's hand from slipping on the gripping surface. Although the user's hand may not slip on the sheath, the sheath itself may slip on the gripping surface. In this situation, the grip-enhancing material can be placed between the sheath and the gripping surface to prevent slipping between the sheath and the gripping surface. This application is illustrated in FIGS. 20A and 20B. FIG. 20A shows a side view of a hand-held power saw 140 with a gripping surface 142 for a user's hand. The gripping surface 142 is covered by a sheath 144. To prevent the sheath 144 from slipping on the gripping surface 142, the grip-enhancing material 117 is attached on an inner surface 146 of the sheath 144, as shown in FIG. 20B. When the sheath 144 is placed on the gripping surface 142 of the saw 140, the sheath 144 engages the gripping surface 142 with friction and/or suction forces to prevent slipping.

The grip-enhancing material can be manufactured and supplied with in various configurations and with various features to make it easier for a user to apply the grip-enhancing material in whatever manner desired.

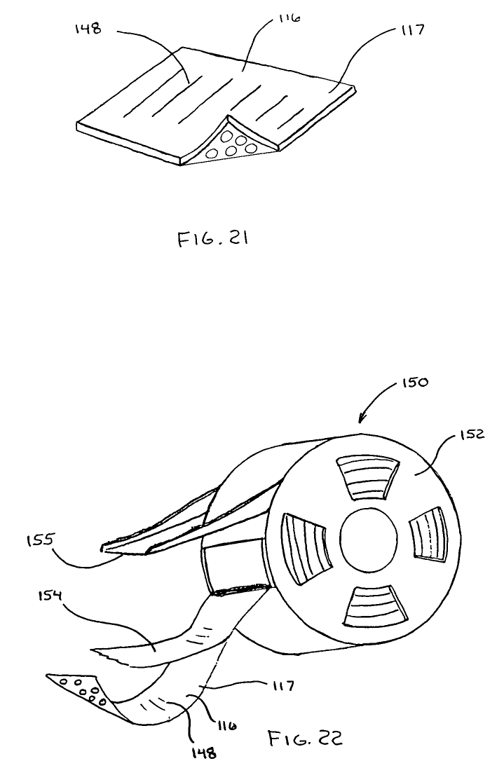

For example, as shown in FIG. 21, the grip-enhancing material 117 can be supplied with adhesive 148 located on the base material 116. One embodiment of the present invention is supplied with permanent adhesive on the base material and can be used to affix the grip-enhancing material to any number of objects as described above, such as a vase, appliances, tools, sporting equipment, rugs, carpet, wall hangings, and furniture. Another embodiment of the present invention utilizes a semi-permanent adhesive on the base material. The semi-permanent adhesive allows the user to remove the grip-enhancing material from an object with relative ease, preferably without leaving any traces of adhesive on the object. However, once the grip-enhancing material that utilizes semi-permanent adhesive has been installed and removed from an object, the semi-permanent adhesive does not maintain its adhesive characteristics to allow the grip-enhancing material to be reinstalled on the same or another object. Yet another alternative embodiment of the grip-enhancing material is supplied with a reusable adhesive on the base material that maintains its adhesive characteristics to allow the grip-enhancing material to be removed and reinstalled on various objects at least once and preferably numerous times. A suitable type of adhesive for the back of the grip-enhancing material is tacky gum adhesive, or other type of material such as the reusable adhesive used on 3M Post-it® Notes.

Depending upon the type of adhesive utilized, a user can also apply the grip-enhancing material directly to a body part, as described in more detail below.

Referring now to FIG. 22, the grip-enhancing material 117 can also be supplied in a roll 150 with a dispenser 152 to allow for ease of application and safe storage of the grip-enhancing material. The dispenser 152 can be configured to house the roll 150 while at the same time keeping the roll from unraveling and protecting the roll from damage. The grip-enhancing material 117 can also be supplied with a removable backing 154, that protects the adhesive 148 located on the base material 116 from becoming dirty or contaminated. The removable backing is typically made from paper, but other suitable materials can also be used, such as plastic. A user that wishes to apply the grip-enhancing material to a particular object can dispense a portion of the grip-enhancing material and cut it to a desired length. As shown in FIG. 22, the dispenser can be configured to have a sharp edge 155 that the user can employ to cut the grip-enhancing material to its desired length. In other applications, the grip-enhancing material is supplied with lateral perforations along its length to allow a user to more easily tear off a piece of the grip-enhancing material. Once the user has removed the piece of grip-enhancing material from the dispenser, the user can cut the grip-enhancing material into whatever shape the user desires. After removing the paper backing, the user can apply the grip-enhancing material to whatever object the user desires. The rolls can vary in width for convenient use.

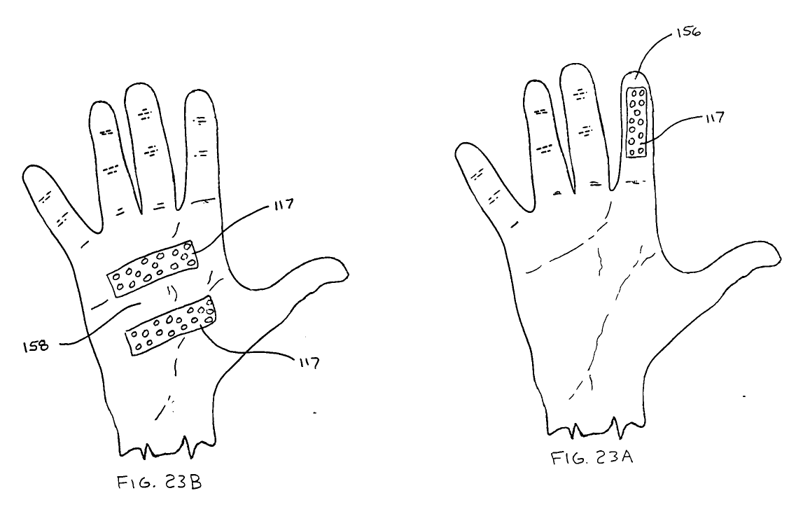

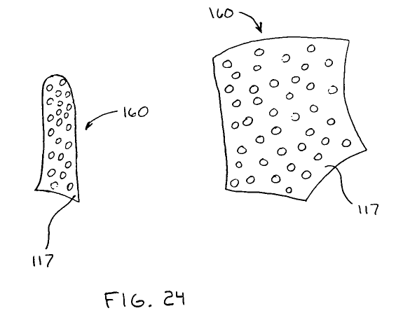

The ability to cut the grip-enhancing material into various shapes along with the adhesive located on the base material makes the grip-enhancing material suitable for application to any number objects. For example, the grip-enhancing material 117 can be applied directly a body part to enhance a user's control of any number of objects. FIG. 23A shows the grip-enhancing material 117 applied directly to a user's finger 156, and FIG. 23B shows the grip-enhancing material 117 applied directly to a user's palm 158. The grip-enhancing material can also be cut to the shape of a user's entire hand (not shown), eliminating the need for grip-enhancing gloves in some applications. In other applications, a user can apply the grip-enhancing material directly to the outside of gloves to enhance his or her control over various objects. In yet other embodiments of the present invention, a user can apply the grip-enhancing material directly to his or her foot, or on the bottoms of various types of footwear, to prevent slipping on a surface, such as on a pool deck or in a public shower and locker room. As described above, the grip-enhancing material 117 is also suitable for application to numerous types of inanimate objects.

The grip-enhancing material 117 can also be supplied in pre-formed shapes. For example, as shown in FIG. 24, the grip-enhancing material 117 can be supplied in pre-formed shapes such as a palm of a hand 160 or a finger 162 to allow for ease of application. As well as pre-formed shapes for ease of application to various body parts, the grip-enhancing material can also be supplied in the pre-formed shapes of surfaces for other common applications, such as the circular bottoms of chair legs.

Presently preferred embodiments of the present invention and many of its improvements have been described with a degree of particularity. It should be understood that this description has been made by way of example, and that the invention is defined by the scope of the following claims.

I claim:

1. A grip-enhancing material for application between a first object and a second object, comprising:
a base material with a first side forming a plurality of recesses therein defining a depth, said recesses formed at a density of approximately 180 to 300 per square inch, wherein said depth of said recesses is approximately 1/64 to 1/32 of an inch,
an adhesive located on a second side of said base material; and
wherein said first object contacts said adhesive and said grip-enhancing material engages said second object upon contact through suction and friction forces.

2. The grip-enhancing material of claim 1 wherein said recesses define diameters of approximately 1/64 or greater inches.

3. The grip-enhancing material of claim 1 wherein said base material is constructed of polyurethane.

4. The grip-enhancing material of claim 1 wherein said adhesive is reusable.

5. The grip-enhancing material of claim 1 wherein said first object is a kitchen appliance.

6. The grip-enhancing material of claim 1 wherein said first object is a human body part.

7. The grip-enhancing material of claim 1 wherein said first object is a glove.

8. The grip-enhancing material of claim 1 further comprising a dispenser for housing said grip-enhancing material.

9. The grip-enhancing material of claim 8 wherein grip-enhancing material is housed in the shape of a roll.

10. The grip-enhancing material of claim 9 further comprising a removable backing connected with said adhesive.

11. The grip-enhancing material of claim 1 wherein said base material is a pre-formed shape.

12. The grip-enhancing material of claim 11 wherein said pre-formed shape is the shape of a finger.

13. The grip-enhancing material of claim 11 wherein said pre-formed shape is circular.

14. A grip-enhancing material for application between a first object and a second object, comprising:
a base material;
a plurality of suction cups connected with a first side of said base material formed at a density of 4 to 7 per square inch, said suction cups defining diameters of approximately ¼ to ½ inches;
an adhesive located on a second side of said base material; and
wherein said first object contacts said adhesive and said grip-enhancing material engages said second object upon contact through suction and friction forces.

15. The grip-enhancing material of claim 14 wherein said base material is constructed of polyurethane.

16. The grip-enhancing material of claim 14 wherein said adhesive is reusable.

17. The grip-enhancing material of claim 14 wherein said first object is a kitchen appliance.

18. The grip-enhancing material of claim 14 wherein said first object is a human body part.

19. The grip-enhancing material of claim 14 wherein said first object is a glove.

20. The grip-enhancing material of claim 14 further comprising a dispenser for housing said grip-enhancing material.

21. The grip-enhancing material of claim 20 wherein grip-enhancing material is housed in the shape of a roll.

22. The grip-enhancing material of claim 21 further comprising a removable backing connected with said adhesive.

23. The grip-enhancing material of claim 14 wherein said base material is a pre-formed shape.

24. The grip-enhancing material of claim 23 wherein said pre-formed shape is the shape of a finger.

25. The grip-enhancing material of claim 23 wherein said pre-formed shape is circular.

26. A grip-enhancing material for application between a first object and a second object, comprising:
a base material;
a plurality of suction cups formed at a density of 14 to 18 per square inch, said suction cups defining a diameter of approximately 1/16 to ¼ inches, wherein each of said plurality of suction cups is connected with a first side of said base material;
an adhesive located on a second side of said base; and
wherein said first object contacts said adhesive and said grip-enhancing material engages said second object upon contact through suction and friction forces.

27. The grip-enhancing material of claim 26 wherein said base material is constructed of polyurethane.

28. The grip-enhancing material of claim 26 wherein said adhesive is reusable.

29. The grip-enhancing material of claim 26 wherein said first object is a kitchen appliance.

30. The grip-enhancing material of claim 26 wherein said first object is a human body part.

31. The grip-enhancing material of claim 26 wherein said first object is a glove.

32. The grip-enhancing material of claim 26 further comprising a dispenser for housing said grip-enhancing material.

33. The grip-enhancing material of claim 32 wherein grip-enhancing material is housed in the shape of a roll.

34. The grip-enhancing material of claim 33 further comprising a removable backing connected with said adhesive.

35. The grip-enhancing material of claim 26 wherein said base material is a pre-formed shape.

36. The grip-enhancing material of claim 35 wherein said pre-formed shape is the shape of a finger.

37. The grip-enhancing material of claim 36 wherein said pre-formed shape is circular.

38. A grip-enhancing material for application between a first object and a second object, comprising:
a base material;
a plurality of suction cups connected with a first side of said base material, each of said plurality of suction cups defining a diameter of ⅛ to 3/16 inches and arranged adjacent to at least one suction cup;
an adhesive located on a second side of said base material; and
wherein said first object contacts said adhesive and said grip-enhancing material engages said second object upon contact through suction and friction forces.

39. The grip-enhancing material of claim 38 wherein said base material is constructed of polyurethane.

40. The grip-enhancing material of claim 38 wherein said adhesive is reusable.

41. The grip-enhancing material of claim 38 wherein said first object is a kitchen appliance.

42. The grip-enhancing material of claim 38 wherein said first object is a human body part.

43. The grip-enhancing material of claim 38 wherein said first object is a glove.

44. The grip-enhancing material of claim 38 further comprising a dispenser for housing said grip-enhancing material.

45. The grip-enhancing material of claim 44 wherein grip-enhancing material is housed in the shape of a roll.

46. The grip-enhancing material of claim 45 further comprising a removable backing connected with said adhesive.

47. The grip-enhancing material of claim 38 wherein said base material is a pre-formed shape.

48. The grip-enhancing material of claim 47 wherein said pre-formed shape is the shape of a finger.

49. The grip-enhancing material of claim 48 wherein said pre-formed shape is circular.
